(19) United States
(12) Patent Application Publication
(10) Pub. No.: US 2026/0002899 A1
(43) Pub. Date: Jan. 1, 2026

(54) THREE-DIMENSIONAL MICROSTRUCTURE PROVIDING ADDITIONAL CURRENT-CARRYING PATHWAYS FOR SENSORS

(71) Applicant: Duke University, Durham, NC (US)

(72) Inventors: Aaron Franklin, Durham, NC (US); Peter Ballentine, Durham, NC (US); Brittany N. Smith, Durham, NC (US)

(21) Appl. No.: 18/757,070

(22) Filed: Jun. 27, 2024

(51) Int. Cl. G01N 27/04; B33Y 10/00; B33Y 70/00; B33Y 80/00

(52) U.S. Cl. CPC G01N 27/048; B33Y 10/00; B33Y 70/00; B33Y 80/00

(57) ABSTRACT

A three-dimensional (3D) microstructure providing additional current-carrying pathways for sensors has a shape of a truss structure. A graphene-based sensor can include a detection surface and a graphene truss structure on the detection surface. The graphene truss structure can be aligned in a direction of connectivity across electrodes of the graphene-based sensor and provided in plurality. The graphene truss structure can be formed of graphene flakes and 3D printed on the detection surface. The 3D printing can be accomplished using aerosol jet printing without post-print processing.

### STATEMENT REGARDING GOVERNMENT FUNDING

This invention was made with Government support under grant number 2139754 awarded by the National Science Foundation and grant number 1R01HL146849 awarded by the National Institute of Health. The Federal Government has certain rights to this invention.

### BACKGROUND

Three-dimensional (3D) microstructures have broad applicability for use in electronics, microfluidics, and biomedical applications. There are many techniques for creating 3D microstructures. One such technique includes additive manufacturing, such as 3D printing.

One printing technology gaining interest for electronics and other applications is aerosol jet printing. Currently, aerosol jet printing is capable of printing electronic components such as resistors, capacitors, antennas, sensors, and transistors. Aerosol jet printing uses aerodynamic focusing to deposit inks onto substrates. The inks used in aerosol jet printing contain particles of the desired printing material in solvent. Depending on the material used, post-print processing may involve thermal and/or photochemical processing (e.g., UV curing).

### BRIEF SUMMARY

A 3D microstructure is provided that can provide an additional current-carrying pathway for sensors. One 3D microstructure shape is a truss structure. A nano-flake material-based truss structure, for example formed of graphene, is described that can be aerosol jet printed to provide an additional current-carrying pathway for a planar sensor.

A sensor can include a detection surface and a 3D microstructure providing additional current-carrying pathways for the sensor. The 3D microstructure can have a shape of a truss structure and can be formed of appropriate nanoflake materials, such as graphene, molybdenum disulfide (MoS₂), or silver nanoflowers (AgNFs). The 3D microstructure can be aligned in a direction of connectivity across electrodes of the sensor and provided in plurality. The 3D microstructure can be printed on the detection surface using aerosol jet printing. The detection surface can be a planar layer on which the 3D microstructure is printed.

A graphene truss structure is suitable for air-based electronic sensors for gas-phase sensing such as moisture/humidity sensors and, when appropriately functionalized, for environmental or biological element detectors.

Accordingly, a graphene-based sensor can include a detection surface and a graphene truss structure on the detection surface. The graphene truss structure can be aligned in a direction of connectivity across electrodes of the graphene-based sensor and provided in plurality. The graphene truss structure can be formed of graphene flakes and 3D printed on the detection surface. The 3D printing can be accomplished using aerosol jet printing without post-print processing. In some cases, the graphene truss structure and detection surface can be functionalized. In some cases, gold nanoparticles can be attached to the graphene and coated with appropriate material for selective detection of various targets.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a representation of a graphene-based sensor with a 3D microstructure as described herein.

FIGS. 2A and 2B show representations of functionalized graphene-based sensors with a 3D microstructure as described herein.

FIG. 3A shows aerosol jet printing functions via the atomization of liquid ink material dispersions.

FIG. 3B shows a Raman spectroscopy plot of as-printed graphene and drop-cast graphene.

FIG. 3C shows an optical image of a single print pass of graphene at a print speed of 0.3 mm/s with optimized printing parameters.

FIG. 4 shows SEM images of a 5-by-5 array of printed pillars with images from left to right iteratively focusing on a single pilar, showing the overspray/roughness of the surface of the pillars.

FIGS. 5A and 5B show the impact of printing speed on a printed structure.

FIGS. 6A, 6B, and 6C demonstrate pillar angles that can be achieved through aerosol jet printing.

FIG. 7A illustrates a process for aerosol jet printing of a graphene truss with a lateral spacing distance of 4 μm.

FIG. 7B is a SEM image of a graphene truss printed according to the process of FIG. 7A.

FIG. 7C is an equivalent circuit of a printed truss.

FIGS. 8A-8C show experimental humidity sensors for a control, pillar, and truss configuration, respectively.

FIG. 9 shows photographs of the experimental set up.

FIGS. 10A and 10B show plots comparing the configurations.

FIG. 11 shows a plot of a percent change in resistance over time.

### DETAILED DESCRIPTION

A 3D microstructure is provided that can provide an additional current-carrying pathway for sensors. Among the wide range of materials used to create 3D microstructures, graphene is one of the most prevalent due to its mechanical strength and electrical conductivity. Numerous techniques have been developed to create 3D graphene microstructures. Current methods typically rely on structural supports, and/or lengthy post-print processing, increasing cost and complexity.

Advantageously, an aerosol jet printing approach can be used to form the described truss structures without any post-print processing such as typically relied upon by current 3D microstructure manufacturing methods. Thus, a graphene truss structure is described that can be aerosol jet printed to provide an additional current carrying pathway for a planar sensor. The graphene truss structure is suitable for air-based electronic sensors for gas phase sensing such as moisture/humidity sensors and, when appropriately functionalized, for environmental or biological element detectors.

Advantageously, instead of simply increasing surface area, the described structures create an additional current-carrying pathway exposed to the sensing environment. Although graphene is specifically described herein, in addition to graphene, other nanoflake materials, such as, but not limited to, MoS₂ and AgNFs, can be used to form the described 3D microstructures providing additional current-carrying pathways for devices.

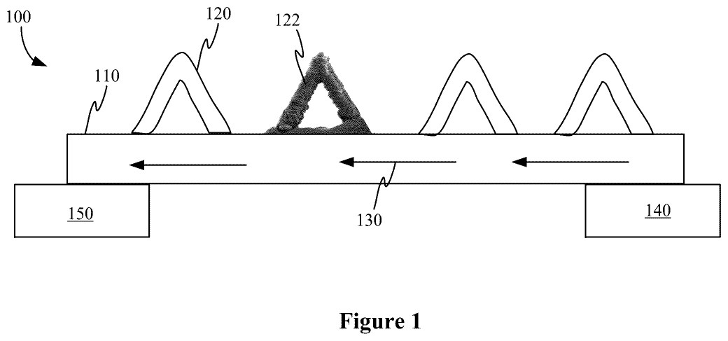

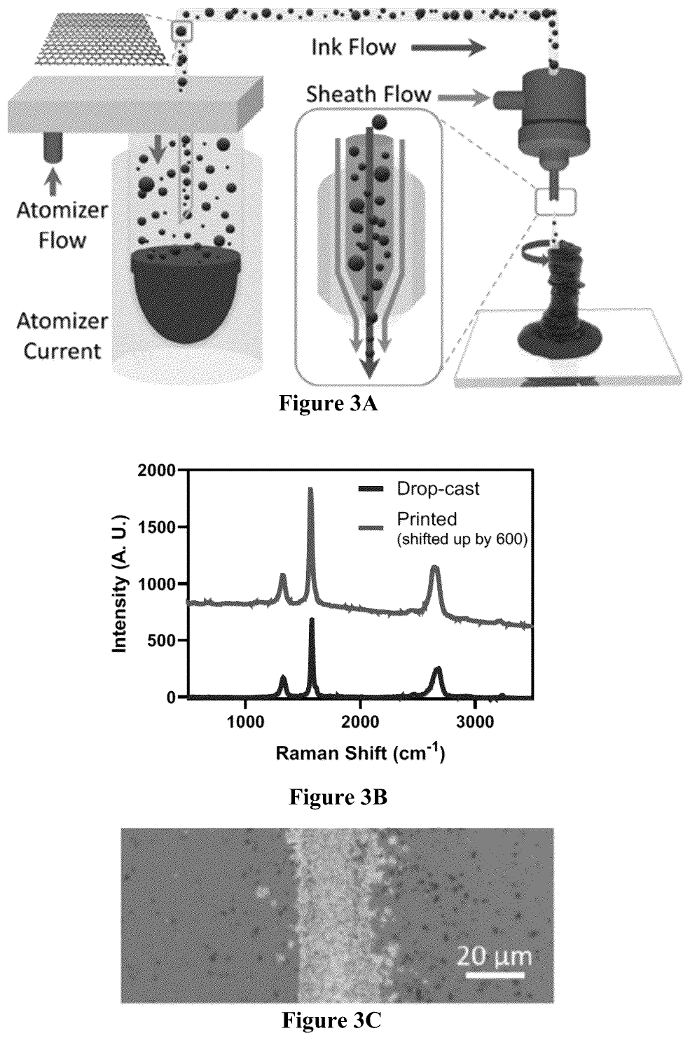

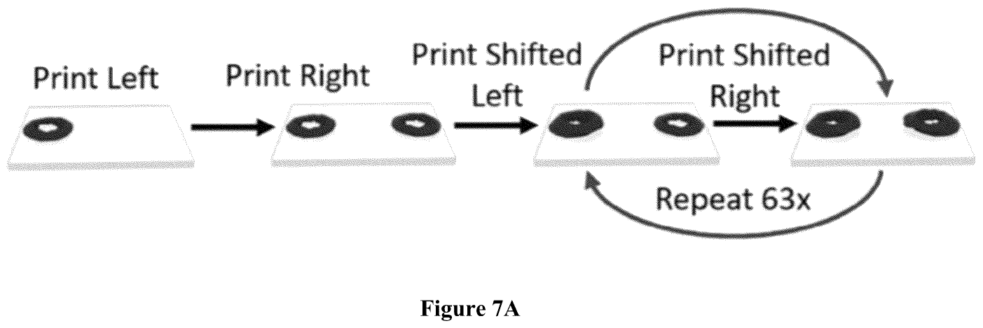

FIG. 1 shows a representation of a graphene-based sensor. Referring to FIG. 1, a graphene-based sensor 100 includes a detection surface 110 and a graphene truss structure 120 on the detection surface. The detection surface 110 can be formed of graphene. In some cases, the graphene material of the detection surface 110 can be deposited using a printing process (e.g., aerosol jet printer or other printer capable of forming the detection surface 110). The graphene truss structure 120 can be formed of graphene flakes 122. The graphene flakes 122 can be disposed in a multitude of orientations, for example, as a result of the manufacturing process. As described in more detail herein, the graphene truss structure 120 can be 3D printed on the detection surface 110. In some cases, the 3D printing of the graphene truss structure is performed using aerosol jet printing, for example, as described with respect to FIGS. 3A and 7A.

As illustrated in FIG. 1, the graphene truss structure 120 can be provided in plurality. In some cases, the graphene truss structure 120 is provided in as many numbers as can fit on a detection surface based on manufacturing constraints. As can be seen, the graphene truss structure 120 is aligned in a direction of a conductive path (e.g., as represented by arrows 130). The conductive path follows a path between two electrodes 140, 150 of the graphene-based sensor.

The graphene-based sensor 100 is suitable as a gas phase sensor, for example, for detecting moisture. In some cases, the graphene-based sensor 100 can be functionalized for a variety of targets by application of various particles, molecules, and/or antibodies. For example, the target can be any compound or element found in air, including, but not limited to, carbon dioxide, fluorocarbons, pollen, and carbon monoxide.

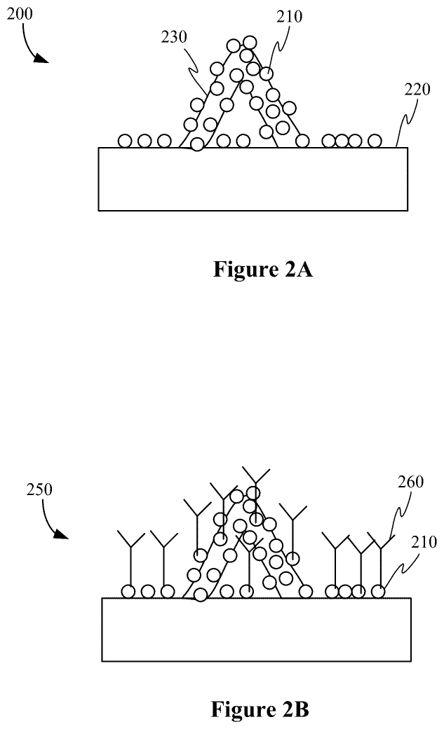

FIGS. 2A and 2B show representations of functionalized graphene-based sensors. Referring to FIG. 2A, a graphene-based sensor 200, which may be implemented such as described with respect to sensor 100 of FIG. 1, can include gold nanoparticles 210 attached to the detection surface 220 and the graphene truss structure 230. The gold nanoparticles 210 can be used to assist with functionalizing the graphene surface as a variety of other materials can more easily attach to the gold nanoparticles 210.

Referring to FIG. 2B, a graphene-based sensor 250 for biological sensing can include an antibody or protein structure 260 attached to the gold nanoparticles 210 of the graphene-based sensor 200 of FIG. 2A. It should be understood, however, that in some cases (not shown in the drawings), the graphene may be functionalized directly with antibodies without use of the gold nanoparticles 210.

FIG. 3A shows aerosol jet printing functions via the atomization of liquid ink material dispersions. Referring to FIG. 3A, utilizing the ultrasonic atomizer, a graphene-based ink is aerosolized while an atomizer flow carries the ink from the vial to nozzle, where a sheath flow keeps the aerosolized column in a tight stream as it exits the nozzle to minimize both clogging and overspray. The graphene concentration of the ink was maximized to 2.3% weight by weight (w/w) in water. At concentrations above 2.3% w/w of graphene, the ink was found to be too viscous to readily print utilizing the ultrasonic atomizer in the study and susceptible to clogging of the nozzle. This concentration of ink produces a fast graphene deposition with rapid solvent evaporation that is sufficient to produce graphene pillars with high structural integrity. To achieve aerosol jet printing of 3D graphene pillars, the ultrasonication power is finely tuned (from 300 to 500 mA) to balance the ink deposition rate, as too rapid or too slow a rate will result in poorly defined 3D structures.

FIG. 3B shows a Raman spectroscopy plot of as-printed graphene and drop-cast graphene. Referring to FIG. 3B, as confirmed by Raman spectroscopy of a single-pass AJP graphene rectangle and drop-cast graphene ink, ultrasonic atomization did not significantly alter the graphene composition during printing. The G peak magnitude (lg) is sufficiently larger than that of the D peak magnitude (Id) for the printed graphene with only a slight increase in the Id/lg ratio from 0.24 for drop-cast graphene to 0.38 for the printed sample, indicating only a small number of impurities were introduced due to ultrasonic atomization and printing.

FIG. 3C shows an optical image of a single print pass of graphene at a print speed of 0.3 mm/s with optimized printing parameters. Referring to FIG. 3C, it can be seen that without any post-processing, the final printed line at a print speed of 0.3 mm/s, with a width of about 25 μm is about 1 μm in thickness and is sufficiently conductive, 0.143 mS/cm, with only a single print pass. This print speed yields a sufficient line thickness to build up 3D graphene structures that are both uniform and reproducible, which enables the in-place printing of large arrays.

Without moving the print nozzle during graphene printing, vertical graphene pillars can be formed upwards of 2 mm tall, with a variable diameter ranging from 10 to 50 μm in a single structure, producing a pillar with an aspect ratio of 40-200. The nozzle can be moved in a repeated motion while the structure grows from the bottom up to produce uniform structures. For instance, wider and more uniform graphene pillars can be formed by successive circular depositions directly atop one another.

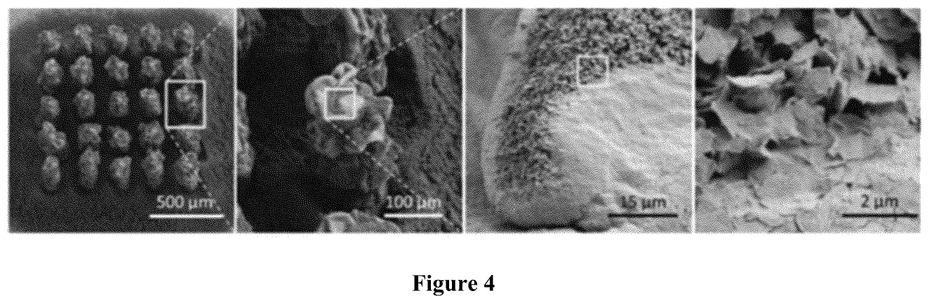

To show the repeatability of printing pillars using successive circular depositions at a print speed of 0.3 mm/s, a 5×5 pillar array of 128 stacked circles per pillar was fabricated. FIG. 4 shows SEM images of a 5-by-5 array of printed pillars with images from left to right iteratively focusing on a single pillar, showing the overspray/roughness of the surface of the pillars. Designing the nozzle print path to be 75 μm diameter circles revealed that the resultant pillars had a diameter of about 100 μm due to the 25 μm deposition line width. Further, despite the built-in 75 μm gap between the printed lines, the pillars appear closed at the top due to excess ink deposition and limited water evaporation, which generates two distinct surface characteristics on the pillars. The smoother portion of the microstructure is where ink is coherently deposited as a jet to form pillars while the rough surface, on the top and around the bottom of the pillar, is individual graphene flakes due to overspray during printing, which is a phenomenon where small errant particles exit the controlled deposition jet stream and deposit already dried ink constituents in an area around the intended deposition location. The graphene flakes seen in the overspray are consistent with the flake distribution provided by the supplier, 500-1500 nm, therefore showing that there is no appreciable reduction in size due to sonication. This largely uniform deposition was achieved through several optimization steps. Slight overspray-induced roughness notwithstanding, the resultant pillar dimensions and appearance are repeatable over the duration of printing time required to produce 25 pillars at 0.3 mm/s about 1.6 min per pillar, about 42 min total. To accomplish the acceleration of solvent evaporation during the experimental study, the platen and ink bath temperatures were raised from room temperature to 120 and 50° C., respectively. Additionally, the atomizer current was closely monitored throughout the print process to ensure no excess solvent deposition.

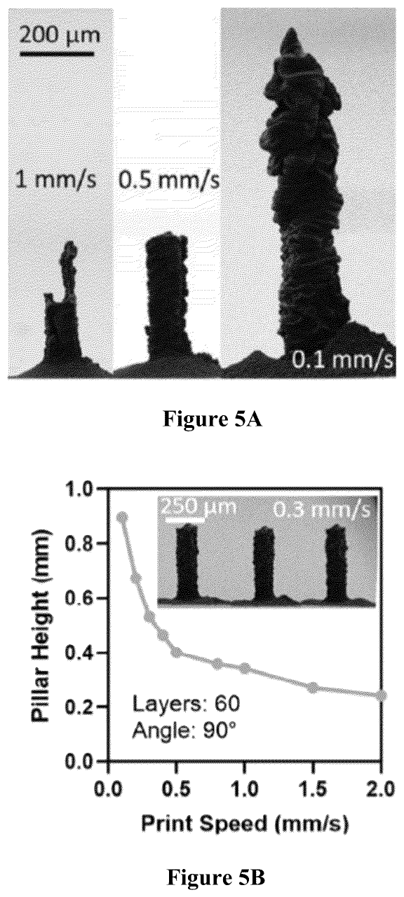

FIGS. 5A and 5B show the impact of printing speed on a printed structure. Referring to FIGS. 5A and 5B, printing speed (defined as X-Y platen movement on an aerosol jet printer) has an impact on the pillar structure, where it can be seen that faster speeds cause a reduction in height. Given that the ink deposition rate was unchanged, there is insufficient graphene deposition at faster print speeds to deposit a uniform line; rather, a significant fraction of the deposition was formed of overspray, which concentrated in specific locations, causing thin spires. As the print speed decreases to 0.1 mm/s, the pillar height increases since the total graphene deposition increases, enabling greater total pillar height. The pillar height showing an inversely proportional trend to print speed is consistent with the theory that the thickness of the printed line is inversely proportional to printing speed, highlighting that the graphene is indeed stacking to form these pillar structures. To alter the surface roughness of the printed structures for specific applications, such as Ag nanoparticle 3D microstructures for battery electrodes, the addition of another binder, which may decrease graphene conductivity without post-processing, or a more-volatile solvent than water may be considered.

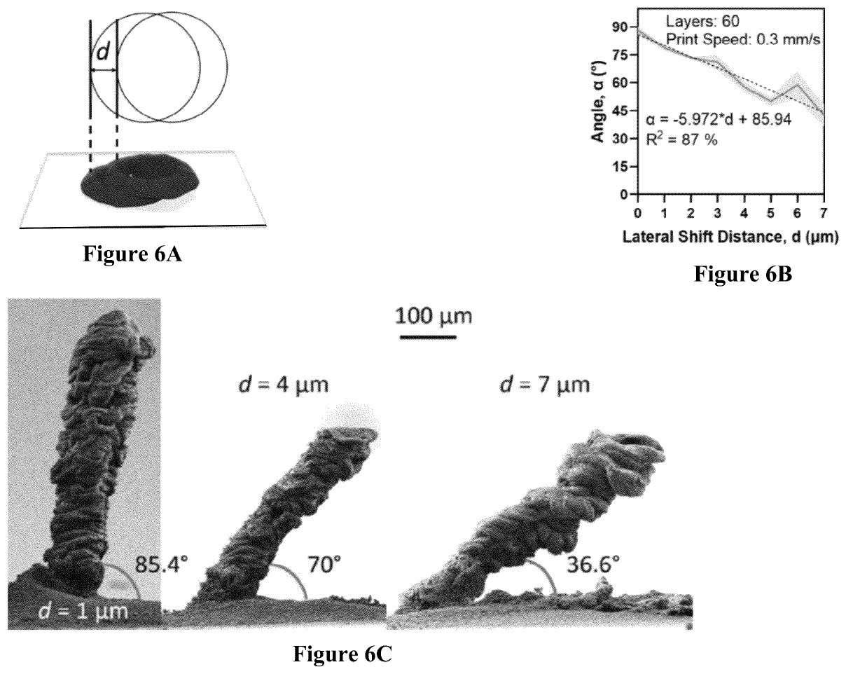

To determine the minimum angle a graphene pillar can achieve by this print method, pillars were printed at 0.3 mm/s with lateral shift distances, d, ranging from 0 to 7 μm between each printed layer. FIGS. 6A, 6B, and 6C demonstrate pillar angles that can be achieved. Referring to FIGS. 6A, 6B, and 6C, in the resulting microstructures, the corresponding angle, a, between the pillar and substrate was measured using a scanning electron microscope, SEM. As the printed circles are spaced further apart (i.e., as d increases), the angle α decreases nearly linearly, achieving down to a 36.6° slanted pillar. Through experimentation, it was determined that beyond a 3 μm lateral shift distance, which yields a 70° angle, an increase in dwell time or drying time is used to create reproducible, uniform structures with a diameter variation below ±20%.

FIG. 7A illustrates a process for aerosol jet printing of a graphene truss with a lateral spacing distance of 4 μm; FIG. 7B is a SEM image of a graphene truss printed according to the process of FIG. 7A; and FIG. 7C is an equivalent circuit of a printed truss. As shown in FIG. 7A, truss structures can be created where the ink deposition alternates between the right and left sides of the structure, allowing for an increased drying time between each layer deposition and more structural support to reduce pillars from falling over post-printing.

Referring to FIG. 7B, as shown in the SEM image of a graphene truss, aerosol jet printing of graphene pillars produces considerable overspray below the trusses. This overspray bridges the gap between the two ends of the truss, creating a parallel conduction pathway as reflected in the simplified equivalent circuit of FIG. 7C.

As evidenced by the examples provided above, a method of manufacturing a graphene-based sensor such as described with respect to FIG. 1 can include depositing a graphene film on electrodes and printing a graphene truss structure on the graphene film. The printing of the graphene truss structure on the graphene film can include alternating printing of layers between a first side of the graphene truss structure and a second side of the graphene truss structure while decreasing lateral spacing of the layers until the graphene truss structure is formed. Here, the ink for performing the aerosol jet printing can include graphene flakes and water. In some cases, additional components may be included in the ink. As is apparent herein, for other nanoflake material-based structures, the ink can include the suitable nanoflake material (and water for example). Examples of other nanoflake material include MoS₂ flakes and AgNFs. In addition, instructions (stored on a storage medium such as hardware memory) can be provided for execution by a printer that alternate printing of layers of ink between a first side of a truss structure forming a 3D microstructure and a second side of the truss structure while decreasing lateral spacing of the layers until the truss structure is formed.

### Humidity Sensor Demonstration

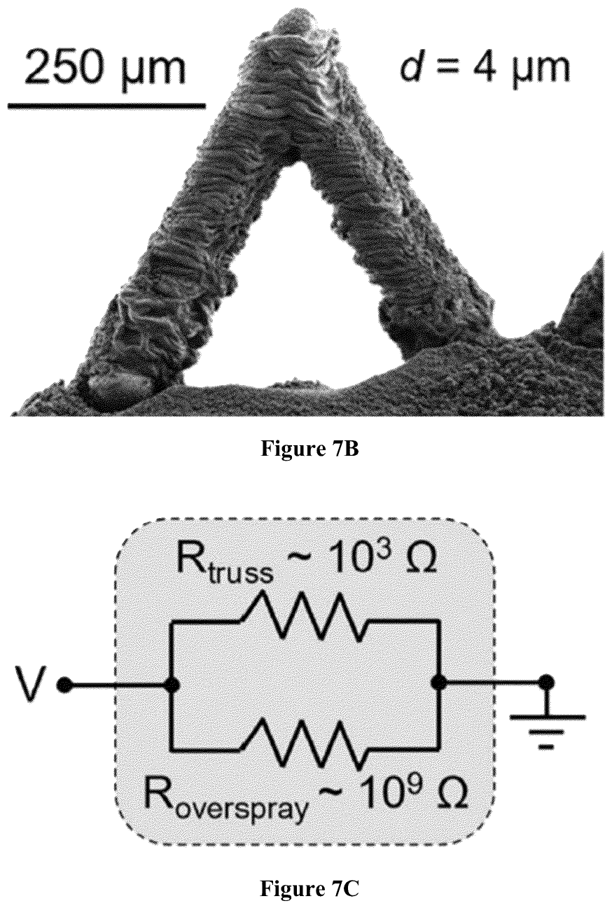

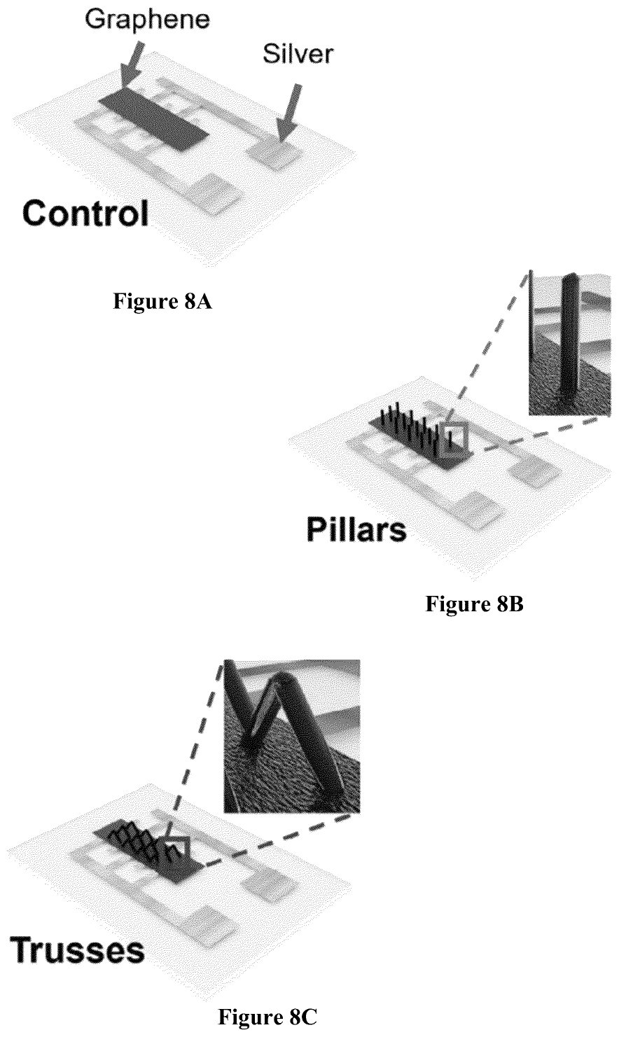

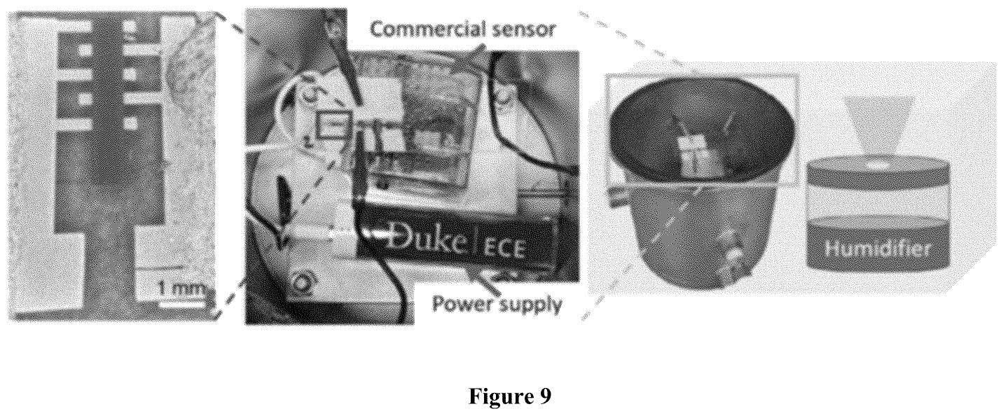

Humidity sensors were fabricated from printed silver nanoparticle (AgNP) interdigitated electrodes (IDEs) with a graphene resistor printed overtop the electrodes. FIGS. 8A-8C show experimental humidity sensors for a control, pillar, and truss configuration, respectively. The printed graphene was enhanced with either fifteen pillars or twelve trusses that bridge the gap between the silver IDEs to determine the influence of such structures on the sensitivity of the sensors. FIG. 9 shows photographs of the experimental set up. FIGS. 10A and 10B show plots comparing the configurations. Referring to FIG. 10A, as can be seen, the stability of the control humidity sensor, without any 3D structure, is relatively steady over a 15 h period under ambient conditions, 20° C. and 39% RH, with only a 2% change in resistance that may be attributed to slight fluctuations in relative humidity over time. The change in resistance (ΔR/R₀) of the three humidity sensor designs was measured between 40 and 50% RH, was monitored by a commercial humidity sensor. As shown in FIG. 10B, the control sensor yielded an average sensitivity of 3.4±1.0% Ω/% RH, which was increased to 5.2±2.0%Ω/% RH when functionalized with trusses. Interestingly, the average sensitivity decreased slightly to 3.2±0.6% Ω/% RH when pillars were added to the graphene, indicating that the increased surface area of the sensing electrode does not necessarily correlate to a higher sensor sensitivity for gas-based sensors, contrary to what is seen in electrochemical sensors. As the humidity is increased to 75% RH, the truss devices continue to have a higher sensitivity than the control and pillar devices, with about a four times higher percent change in resistance (about 2300%) than the control device (about 600%) at 75% RH. Even under high RH environments, the trusses have a distinct advantage over the control and pillar humidity sensors.

As shown by the experiments, the 3D truss microstructures demonstrate a substantial increase in air-based sensitivity to boost humidity sensor performance.

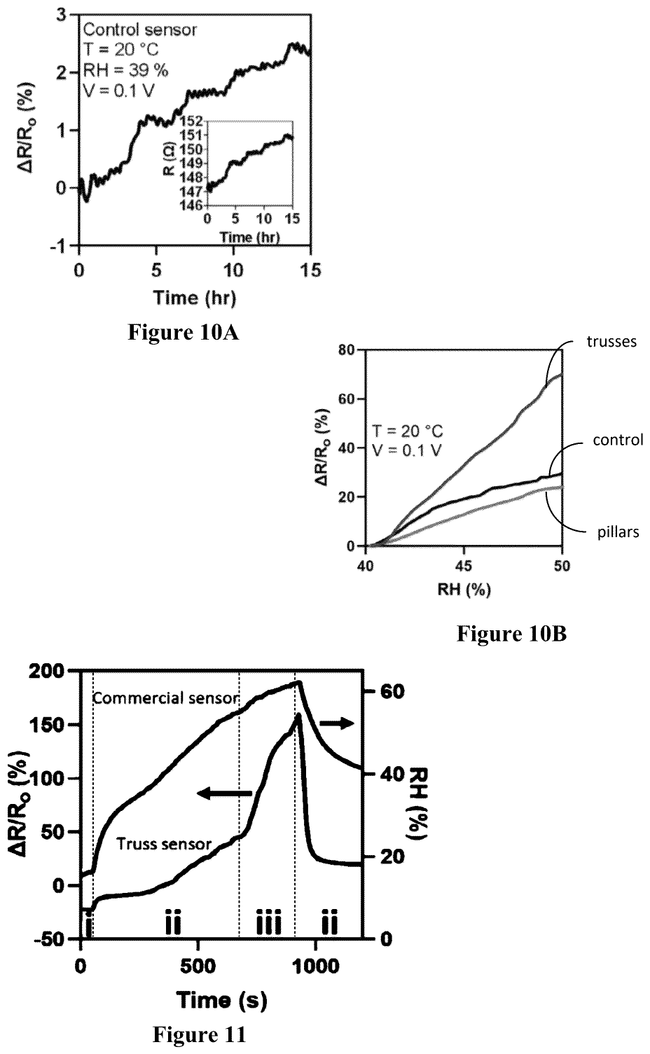

To further characterize the response of the graphene humidity sensor enhanced with graphene trusses, the sensor was exposed to relative humidity ranging from 15% to 60%. FIG. 11 shows a plot of a percent change in resistance over time. Referring to FIG. 11, it can be seen that under nitrogen, the relative humidity was stable at 15% and the corresponding sensor response was also considerably steady. When the chamber is opened to ambient air, 39% RH, the commercial sensor and graphene sensor track the relative increase in humidity within the chamber. As the humidity is increased at a faster rate with the addition of a humidifier, up to 60% RH, the graphene sensor tracks this change more quickly than that of the commercial sensor, demonstrating a more rapid reaction time. However, as the humidity rose to 60% RH, water droplets started to form on the sensor, inducing a large spike in resistance. Finally, as the chamber was removed from the humid environment back to ambient humidity, the sensor resistance decreased and stabilized quicker than that of the commercial sensor, plotted as the % RH in FIG. 11, further confirming that this sensor has a faster reaction than that of the commercial sensor. The improved sensor performance and fast response time to change in humidity demonstrates the utility of graphene trusses for use in fully printed air-based sensors.

The following provides details of the methods and materials used in the demonstration.

Graphene Ink Preparation and Printing: Graphene ink (Sigma-Aldrich 80556-10ML at 7 wt. % graphene concentration in water with 5-10 wt. % sodium deoxycholate) was diluted with DI water to a 2.33 wt. % graphene concentration. This ink has flake sizes ranging from 500-1500 nm. The ink was printed with an OPTOMEC AJ300 aerosol jet printer using a 150 μm nozzle and the ultrasonic atomizer. The distance between the nozzle and the substrate was kept at a constant 3.5 mm throughout each print. The sheath flow was set at 25 SCCM and the carrier gas flow was kept in the range of 35-42 SCCM. The platen and ink bath temperatures were 120 and 50° C., respectively. The atomizer current ranged from 300 to 500 mA. The printing speed varied depending on the print.

Silver Nanoparticle Ink Preparation and Printing: Silver nanoparticle ink (Ag40 x, UT Dots Inc. USA) was diluted with terpinol in a 9:1 ratio. The ink was printed with an OPTOMEC AJ300 aerosol jet printer using a 150 μm nozzle and the ultrasonic atomizer at a current of 350 mA. The sheath and atomizer gas flow rates were set at 25 and 20 SCCM, respectively. The ink bath temperature was 20° C. and the platen temperature was 60° C. during printing. A print speed of 9 mm/s was used for all silver ink printing. Post printing, the printed AgNP electrodes were annealed at 200° C. for 1 hour to improve electrical conductivity.

Humidity Sensor Fabrication: The humidity sensors were printed on glass slides. All substrates were cleaned by rinsing with isopropyl alcohol (IPA), rinsing with deionized (DI) water, and blowing dry using nitrogen. The interdigitated AgNP electrodes were printed with the above printing parameters with a gap of 450 μm between the five electrodes with dimensions of 1.96 mm×170 μm. A 1.25 mm×4.25 mm graphene electrode was printed between the interdigitated electrodes with the above printing parameters using a 2 mm/s print speed. Finally, to functionalize the sensors with 15 pillars or 12 trusses, the graphene was printed with the same parameters but at a print speed of 0.3 mm/s.

Humidity Sensor Testing: Ag epoxy was added to the AgNP electrodes of the humidity sensors to expand the electrode to allow for an alligator clip to be attached to the electrode. The measurements of the sensors were carried out by a SMU (Keysight B2902A). The relative humidity was monitored by a commercial sensor (SensorShare SDAWIR01/02), retrieving data from the sensor every 10 s. The sensors were placed in a chamber so that humidity can be easily altered by the addition of nitrogen or water vapor.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A sensor, comprising:
a detection surface; and
a 3D microstructure on the detection surface, wherein the 3D microstructure has a shape of a truss structure and comprises a nanoflake material.

2. The sensor of claim 1, wherein the 3D microstructure is aligned in a direction of a conductive path between electrodes of the sensor.

3. The sensor of claim 1, wherein the 3D microstructure is provided in plurality.

4. The sensor of claim 1, wherein the 3D microstructure comprises graphene flakes, molybdenum disulfide (MoS₂), or silver nanoflowers (AgNFs).

5. The sensor of claim 4, wherein the graphene flakes are disposed in a multitude of orientations.

6. The sensor of claim 1, wherein the detection surface comprises graphene.

7. The sensor of claim 1, wherein the 3D microstructure is 3D printed on the detection surface.

8. The sensor of claim 7, wherein 3D printing of the 3D microstructure is performed using aerosol jet printing.

9. The sensor of claim 1, further comprising gold nanoparticles attached to the detection surface and the 3D microstructure.

10. The sensor of claim 9, further comprising an antibody or protein structure attached to the gold nanoparticles.

11. The sensor of claim 1, further comprising an antibody or protein structure attached to the detection surface and the 3D microstructure.

12. The sensor of claim 1, wherein the sensor is a gas phase sensor.

13. The sensor of claim 12, wherein the sensor detects moisture.

14. A method of manufacturing the sensor of claim 1, the method comprising:
depositing a planar film on electrodes; and
printing a nanoflake material-based truss structure on the planar film.

15. The method of claim 14, wherein printing the nanoflake material-based truss structure on the planar film comprises performing aerosol jet printing.

16. The method of claim 14, wherein printing the nanoflake material-based truss structure on the planar film comprises:
alternating printing of layers between a first side of the truss structure and a second side of the truss structure while decreasing lateral spacing of the layers until the nanoflake material-based truss structure is formed.

17. The method of claim 15, wherein ink for the performing of the aerosol jet printing comprises nanoflake material and water.

18. The method of claim 17, wherein the nanoflake material comprises graphene flakes, MoS₂ flakes, or AgNFs.

19. The method of claim 14, wherein the truss structure is aligned in a direction of a conductive path between the electrodes of the sensor.

20. A storage medium storing instructions that when executed by a printer, direct the printer to:
alternate printing of layers of ink between a first side of a truss structure forming a 3D microstructure and a second side of the truss structure while decreasing lateral spacing of the layers until the truss structure is formed, wherein the ink comprises nanoflake material.
